(19) United States
(12) Patent Application Publication
(10) Pub. No.: US 2007/0079588 A1
(43) Pub. Date: Apr. 12, 2007

(54) Air Cleaning Ceiling Fan Blades

(76) Inventor: Steven Busick, Pembroke Pines, FL (US)

Correspondence Address: STEVEN C. BUSICK, 1161 N.W. 87 WAY, PEMBROKE PINES, FL, 33024, US

(21) Appl. No.: 11/163,240

(22) Filed: Oct. 11, 2005

(51) Int. Cl. B01D 46/10

(52) U.S. Cl. 55/385.1; 55/495

(57) ABSTRACT

A ceiling fan for cleaning air in a room wherein each blade of the ceiling fan has a filter holder securely attached to the top of each fan blade and a filter unit in each of the holders but within the confines of the fan blade such that, when the ceiling fan is operated, the airflow created by the ceiling fan will be forced through the filter unit from an opening on the leading edge through to an opening the adjacent edge, wherein the filter units can collect airborne particles.

It is an aim of the present invention to provide a fan with filter means for cleaning air. Further aim of the present invention to provide a fan in which the filter components are incorporated on top of the fan blades and their frontal attack planes are substantially parallel to the flow of air created by the fan.

It is yet another aim of the present invention to provide a ceiling fan that incorporates an air cleaning device within the confines of the Filter Holder such that the fan may be designed as any conventional fan and the filters are not readily apparent or obtrusive.

It is a further aim of the present invention to provide for the use of a variety of high quality particulate and absorbent filters without regard for the structural properties of the filters.

It is a further aim of the present invention to incorporate a ceiling fan having an electrically charged filter in the filter holder on top of the fan blades and absorbent filters can also be added into the fan blade filter holder in combination with the electrically charged filters to adsorb gases and odors.

It is a further aim of the present invention to provide air cleaning ceiling fan blades that can be universally attached to an existing ceiling fan.

A construction in accordance with the present invention comprises a fan blade for a fan, the blade including a front surface and a parallel rear surface defined by a peripheral edge including side edge segments as well as a blade tip edge segment. At least one filter unit is to be permanently seated on top of at least one blade such that, as the fan is operated, the filter unit will be in a substantially low profile parallel plane to the direction of the airflow created by the fan.

In another aspect of the present invention, a fan is provided having a fixed frame, a motor mounted to the frame, a rotatable hub mounted to the motor, and a plurality of fan blades mounted for rotation on the hub and extending radially from the hub in a plane of rotation, a plurality of electrically charged filter units mounted on top of at least some of the blades, wherein the blades having the filter holders on opposed surfaces of the blades so that airborne particles present in the airflow created by the fan, when in operation, may be readily captured by the filter units in the blades

### DESCRIPTION OF THE DRAWINGS

FIG. 1 shows an opening for air Intake (1), also an opening for air exhaust and filter insertion/retraction (2).

FIG. 2 shows another view of the air intake opening (1), also an end sealed to prevent airflow (3).

FIG. 3 shows ridges or grooves along the ceiling to allow airflow over the top of the filter element (4).

FIG. 4 shows another view of the opening for air intake (1), also ridges or grooves along the ceiling to allow airflow over the top of the filter element (4).

FIG. 5 shows the low profile aerodynamic sides to reduce airflow resistance (5), also another view of the opening for air exhaust and filter insertion/retraction (2).

FIG. 6 shows the complete air filter holder (6), attached in place on a typical ceiling fan blade (7), together as one unit.

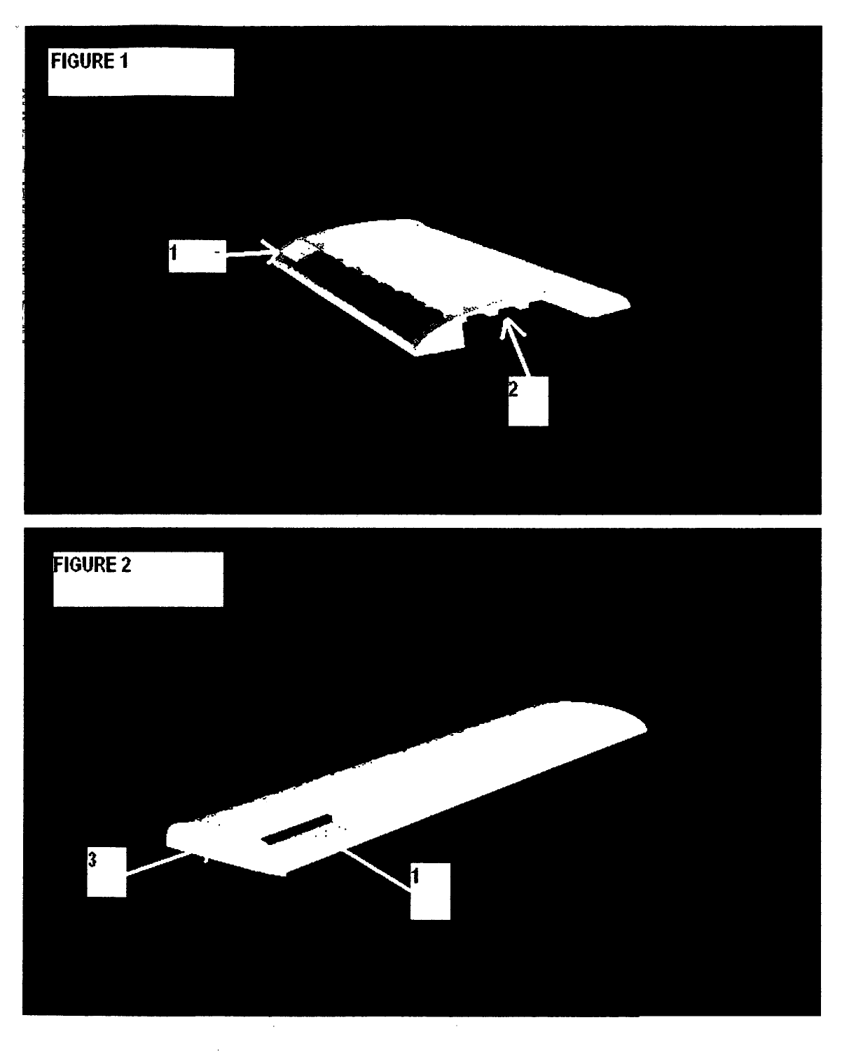

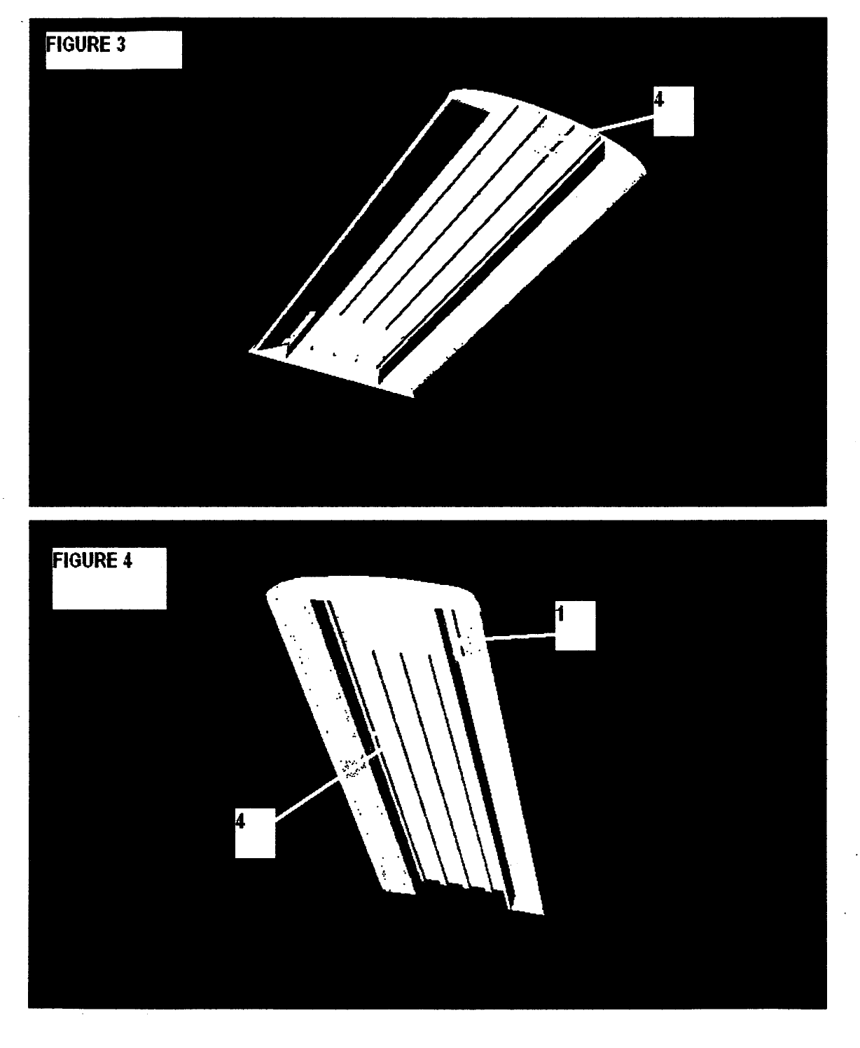

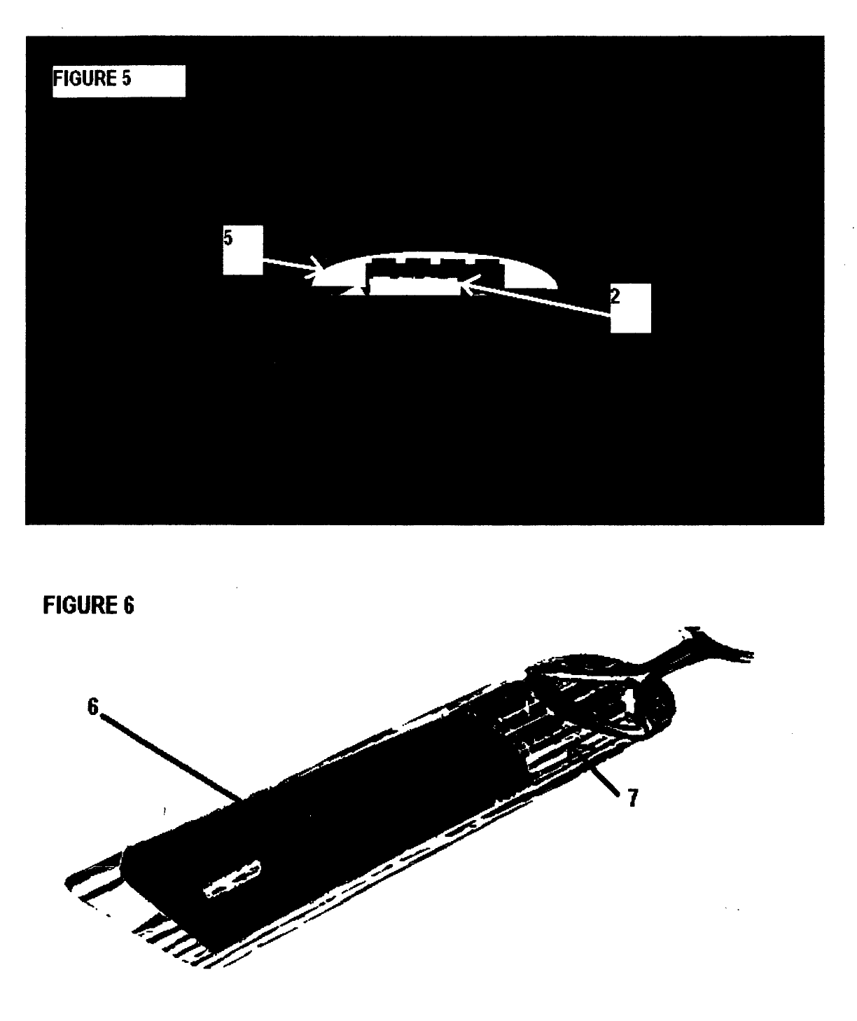

What is claimed is:

1. A fan, comprising: a plurality of radially extending fan blades, wherein at least one fan blade comprises a first surface and a parallel second surface defined by a peripheral edge including side edge segments, the at least one fan blade also including a frame permanently attached to the top, the frame defining a seat comprising a solid support structure covering the at least one fan blade, at least one filter unit adapted to be seated in the at least one frame and supported by the internal support structure such that, as the fan is operated, the at least one filter unit will be in a substantially parallel plane to a direction of airflow created by the fan for filtering airborne particles from the airflow.

2. The fan as defined in claim 1, wherein the fan is a ceiling fan.

3. The ceiling fan as defined in claim 2, wherein the first surface of the at least one fan blade is a top surface thereof relative to the ceiling fan and the solid frame structure covers at least one top side.

4. The ceiling fan as defined in claim 3, wherein the solid filter holder support structure is a structural device having at least one opening for air inlet and at least one opening for air outlet and is permanently mounted to the fan blade.

5. The ceiling fan as defined in claim 2, wherein the at least one cavity extends for the major area of the at least one filter holder and the frame is coincident with the side edge segments, and the at least one filter unit extends throughout the at least one cavity and is co-extensive with the first and second surfaces.

6. The ceiling fan as defined in claim 2, wherein the fan includes a rotating hub, and the fan blades are mounted to the rotating hub, and each fan blade has a root portion with a mounting bracket for mounting to the rotating hub, a fan blade body replaceably connected to the root portion of the fan blade, and the fan blade body of the at least one fan blade including the frame defining the at least one side.

7. A filter unit for use in a cavity of a filter holder of a fan blade, the fan blade having a root, tip and side edges and the filter holder extending for the full extent of the top side of blade with filter holder margins being defined by the root portion of the blade, the tip portion of the blade, and side frame members, the filter unit including filter material within the filter holder, the filter holder including side portions adapted to cooperate with the side frame members of the fan blade, the filter holder further including a root end portion and a tip end portion.
